(19) United States
(12) Patent Application Publication
(10) Pub. No.: US 2009/0024466 A1
(43) Pub. Date: Jan. 22, 2009

(54) METHOD AND SYSTEM FOR SELLING DISCOUNTED FUEL

(75) Inventor: Randall Gene Shoemake, Independence, MO (US)

Correspondence Address: HOVEY WILLIAMS LLP, 10801 Mastin Blvd., Suite 1000, Overland Park, KS, 66210, US

(73) Assignee: MCKEEVER ENTERPRISES, INC., Independence, MO (US)

(21) Appl. No.: 11/780,954

(22) Filed: Jul. 20, 2007

Related U.S. Application Data
(63) Continuation-in-part of application No. 11/557,852, filed on Nov. 8, 2006.

(51) Int. Cl. G06Q 30/00

(52) U.S. Cl. 705/14

(57) ABSTRACT

A system and method for selling discounted fuel which takes advantage of the efficiencies, lower transactional costs, and other savings of grocery stores and similar businesses to provide discounts at conventional fuel stations. The method is implemented by a grocery store or other business; a host computer system; one or more participating fuel stations; and a communications network for providing communications between the host computer system, the business, and the fuel station.

### CROSS REFERENCE TO RELATED APPLICATION

This application is a continuation-in-part (CIP) of application Ser. No. 11/557,852, entitled METHOD AND SYSTEM FOR SELLING DISCOUNTED FUEL, filed on Nov. 8, 2006, and hereby incorporates this prior application by reference.

### BACKGROUND

1. FIELD

The present invention relates to methods and systems for selling discounted fuel. More particularly, the invention relates to a method and system which takes advantage of the efficiencies and lower transactional costs of grocery stores and similar businesses to provide discount fuel at conventional fuel stations

2. Description of the Related Art

Consumers are becoming increasingly concerned about fuel prices and are taking steps such as buying more fuel efficient vehicles, making fewer trips, and comparison shopping for the lowest priced fuel in an attempt to lower their total fuel costs. Unfortunately, consumers unknowingly increase the price of fuel by paying for their fuel purchases with credit cards. Consumers often prefer paying with credit cards because of the convenience of paying at the pump rather than inside at a cashier station. Some jurisdictions even require that fuel be paid for at the pump to prevent thieves from fueling their vehicles and then driving off without paying. Many consumers don't realize, however, that paying for fuel (and other goods and services) with credit cards increases the costs of the fuel. Credit card companies charge fuel stations and other businesses fees every time a credit card is used for payment. These fees, which are typically between 1-5% of the price of the goods and services purchased, are then passed on to consumers by way of higher prices. Even consumers who pay with cash or checks instead of credit cards can't avoid these higher prices because most fuel stations have discontinued the practice of charging less for fuel purchased with cash or checks. Credit card companies also typically charge businesses other fees such as switch fees each time a purchase is processed with a credit card.

Credit card companies charge different fees to different types of businesses based on the credit risk of the businesses and the processing procedures followed. For example, fees for businesses which swipe credit cards, verify signatures, and obtain electronic pre-authorization are less than for those who don't. Unfortunately, fuel stations are charged higher credit card fees than many other businesses because consumers frequently pay at the pump, thus preventing signature verification. Moreover, fuel stations have a higher percentage of purchases made with credit cards than many other businesses because consumers can't pay with cash or checks at the pump. Thus, fuel stations must increase their prices more than many other types of businesses to offset credit card fees.

Discount stores and other businesses have begun to sell fuel to their customers at prices which are perceived to be lower than average fuel prices. However, customers typically must become “members” of the discount stores in order to purchase discounted fuel and often must drive out of their way to find a fuel station associated with the discount store. Thus, much if not all of the perceived fuel price savings are offset by membership fees and the costs associated with driving to inconvenient fuel stations.

### SUMMARY

The present invention solves many of the above-described problems by providing an improved system and method for selling discounted fuel. As described in more detail below, the invention takes advantage of the efficiencies, lower transactional costs, and other savings of grocery stores and similar businesses to provide discount fuel at conventional fuel stations.

One embodiment of the present invention is implemented by a grocery store or other business; a host computer system; one or more participating fuel stations; and a communications network for providing communications between the host computer, the business, and the fuel station. The grocery store uses point-of-sale equipment to issue discount fuel cards when consumers purchase other non-fuel goods or services. For example, the grocery store may permit a consumer to purchase a discount fuel card having a $50 fuel value if the consumer also buys $50 or more worth of non-fuel goods or services such as groceries. Once a discount fuel card has been purchased, the grocery store transmits an identification number for the fuel card and an indication of the purchased fuel value to the host computer system so that the computer may authenticate the card and settle funds when the card is presented at a fuel station. The fuel cards may be configured as fleet cards and have corresponding IIN number ranges which allow them to be processed outside of conventional credit card settlement methods.

The host computer system may be any number or combination of conventional computers and is in communication with the grocery store and fuel station via the communications network. The host computer may be operated by the grocery store, the fuel station, or a third party entity. However, the host computer is preferably not operated by or affiliated with any credit card companies.

The participating fuel station may be any fuel station and does not have to be owned or otherwise affiliated with the grocery store. The fuel station includes at least one fuel pump which is directly or indirectly in communication with the host computer system. When the discount fuel card is inserted into the credit card reader or other card reader at the fuel pump, the fuel pump recognizes the identification number on the card as being a part of the discounted fuel program. The fuel station then sends a request for card authorization to the host computer and rolls back its posted price to reflect the discount provided by the fuel card. Once the fuel has been dispensed, the fuel pump transmits an indication of the total price of the fuel dispensed to the host computer. The host computer then settles funds between the fuel station and the issuer of the card by transferring funds from the card issuer to the fuel station.

The fuel station is able to provide discounted fuel because it can accept the discount fuel card without incurring traditional credit card processing fees. For example, a fuel station with an average 4% credit card fee and a non-discounted price of $3 per gallon may discount its price by 12 cents per gallon. Because the fuel pump rolls back its posted price right at the pump, the consumer immediately knows he or she is receiving the discount and is therefore more likely to frequent the fuel station on a regular basis. The fuel station is therefore encouraged to become a participant in the discounted fuel program because it can sell discounted fuel without losing revenue and may actually gain revenue through increased sales.

The grocery store or other business is able to provide the discount fuel card for several reasons. First, the grocery store is charged lower fees by credit card companies because it verifies signatures and has lower risks. Second, because the grocery store has a higher percentage of purchases made with cash or checks, the fuel card is more likely to be purchased by a consumer without incurring any credit card fees. Third, even if the fuel card is purchased with a credit card, the transactional switch fee charged by the credit card companies is no more than it would have been without the sale of the fuel card because the grocery store requires purchase of non-fuel items with the fuel card in a single transaction. Fourth, the grocery store gets to keep the money paid for the fuel card until it is used to purchase fuel and gets to keep at least a portion of the price paid for fuel cards which are lost or otherwise never used. By combining all of these cost savings, efficiencies and benefits, the grocery store may offer the discount fuel card at no charge or a minimal charge. In some embodiments, the grocery store may even realize enough savings and efficiencies to sell the discount fuel card at a reduced price, e.g. offering a $50 fuel card for $49.

The grocery store or other business which initially sells the discount fuel card or the fuel stations which accept the card may also add value to the card beyond the amount purchased by the consumer. For example, the entity which sells the card may add value to the card when a consumer buys promotional items (e.g. if a consumer buys four 2-liter bottles of Coke®, he receives an additional $2 on his fuel card) or when the consumer purchases a certain amount of groceries or other items (e.g. a consumer receives $2 credit on her fuel card for every $100 worth of groceries purchased). The entity which sells the card may also convert reward points and other credits from loyalty cards to the fuel card (e.g. a consumer may receive $5 credit on his fuel card for every 1,000 points on a frequent shopper card).

Similarly, the fuel stations which accept the cards may add value to the cards when consumers purchase non-fuel items (e.g. when a consumer buys a soda and a sandwich she receives $0.50 on her fuel card) or based on repeated use of the card (e.g. a consumer receives $2 credit on his card every fifth time he uses the card for a vehicle fill-up).

These and other important aspects of the present invention are described more fully in the detailed description below.

### BRIEF DESCRIPTION OF THE DRAWING FIGURES

Embodiments of the present invention are described in detail below with reference to the attached drawing figures, wherein:

FIG. 1 is a schematic diagram of equipment which may be used to implement an embodiment of the present invention;

FIG. 2 is an illustration of an exemplary discount card which may be used with the present invention; and

FIG. 3 is a flow diagram depicting selected steps of a method of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

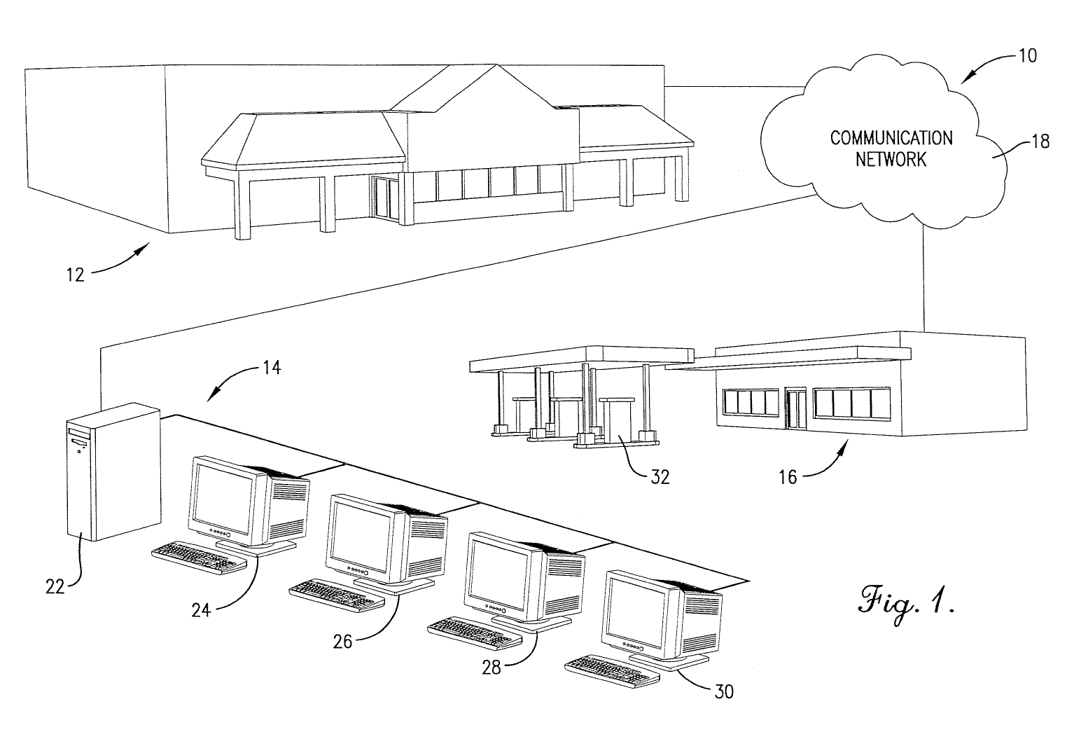

The present invention can be implemented in a variety of ways and with various different equipment and computer programs. As illustrated in FIG. 1, one embodiment is implemented by a system broadly referred to by the numeral 10 and including a business 12 such as a grocery store; a host computer system 14; one or more participating fuel stations 16, and a communications network 18 for providing communications between the host computer, the grocery store, and the fuel station.

The business 12 may be any entity which can take advantage of the efficiencies, lower transactional costs, and other savings described below to provide discounts for fuel. In one embodiment, the business is a grocery store or grocery store chain such as the Price Chopper grocery store chain headquartered in Independence, Mo. The business may also be a liquor store, a convenience store, a clothing store, a hardware store, a drug store, a discount store, a warehouse store, a sporting goods store, a restaurant, a financial institution, or any other entity which can provide the benefits described herein.

The business 12 includes at least one conventional point-of-sale station that is equipped to issue and record information relating to discount fuel cards. The point-of-sale station may include a conventional cash register, credit card reader, and related computing devices and is directly or indirectly in communication with the host computer 14 via the communication network 18.

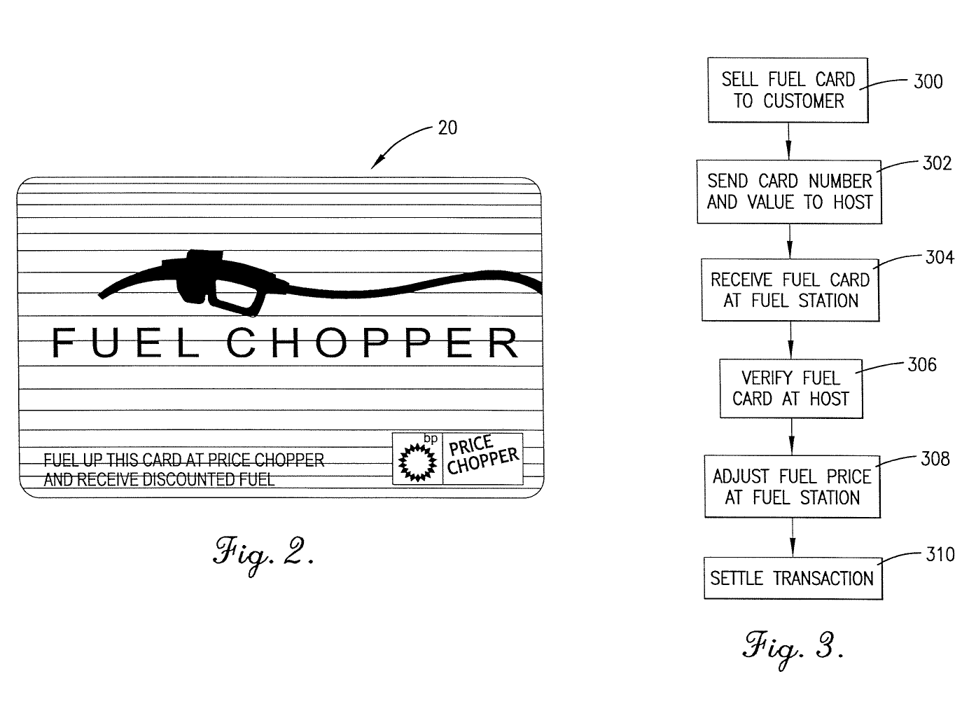

An example of a discount fuel card 20 that may be issued by the business is illustrated in FIG. 2. The discount fuel card may be of any size and constructed of any suitable materials but is preferably similar to conventional credit or debit cards. In one embodiment, the card is approximately 3¼ inches long, 2⅛ inches wide, and formed of 30 mil. plastic or other synthetic resin materials. The back of the card includes a HICO 3-track mag stripe for encoding certain information such as a card identification number, a random pin number, and the name of the cardholder. The card may also include a snap-off coupon which can be redeemed for goods or services at the fuel station 16 or other business. For example, the card may include a snap-off coupon which permits the holder of the card to receive a free soda at the fuel station.

The host computer system 14 may be any number or combination of conventional computers and is in communication with the grocery store and fuel station via the communications network 18. The host computer may be operated by the grocery store, the fuel station, or a third party entity. However, the host computer is preferably not operated by or affiliated with any credit card companies so that no credit card transactional fees are incurred as described below.

The host computer 14 serves as a financial intermediary or clearinghouse between the business 12 and the participating fuel stations 16 and serves as a repository for data and programs used to implement certain aspects of the present invention as described in more detail below. In one embodiment, the host computer system 14 includes a network computer 22 running Windows NT, Novel Netware, Unix, or any other network operating system. The network computer 22 may be connected to other computing devices 24, 26, 28, 30 that serve as a firewall to prevent tampering with information stored on or accessible by the host computer or as workstations for salespeople, administrators or other persons. The host computer system 14 may include conventional web hosting operating software, an Internet connection such as a modem, DSL converter or ISDN converter, and may be assigned a URL and corresponding domain name so it can be accessed via the Internet in a conventional manner. The operator of the host computer system 14 may also have conventional phones and/or e-mail accounts for enabling a help desk which can be contacted by consumers and/or employees of the business or participating fuel stations.

The participating fuel station 16 may be any fuel station and does not have to be owned or otherwise affiliated with the business 12. Any number of participating fuel stations may be part of the discount fuel program. Each participating fuel station includes at least one fuel pump 32 which is directly or indirectly in communication with the host computer system 14 via the communications network 18. The fuel pump 32 is configured to accept the discount fuel card 20, read the information encoded on the card, recognize the card identification number as being part of the discount fuel program of the present invention, and communicate with the host computer system as described in more detail below. The fuel pump may include a Midax black box or other similar architecture that permits it to communicate with the host computer and perform the other functions described herein.

The communications network 18 may be any conventional communications network such as a local area network, a wide area network, a wireless network, a hard-wired private network, the Internet, or an intranet. In preferred forms, the communication network permits the business 12 and the participating fuel stations 16 to communicate with the host computer system 14 via a broadband virtual private network connection with DSL or T1 line.

Certain aspects of the present invention may be implemented with one or more computer programs stored in or on computer-readable medium residing on or accessible by the host computer system 14, the point-of-sale equipment at the business 12, other computing equipment at the business 12, and/or the fuel pump 32 or related computer equipment at the fuel station 16. Each computer program preferably comprises an ordered listing of executable instructions for implementing logical functions in the host computer system 14 and the computing equipment at the business 12 and participating fuel stations 16. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

The flow chart of FIG. 3 shows the functionality and operation of an exemplary implementation of the present invention in more detail. In this regard, some of the blocks of the flow chart may represent a module segment or portion of code of the computer programs of the present invention which comprise one or more executable instructions for implementing the specified logical function or functions. In some alternative implementations, the functions noted in the various blocks may occur out of the order depicted in FIG. 3. For example, two blocks shown in succession in FIG. 3 may in fact be executed substantially concurrently, or the blocks may sometimes be executed in the reverse order depending upon the functionality involved.

As generally depicted by block 300 in FIG. 3, the business 12 first uses its point-of-sale equipment to issue a discount fuel card 20 to a consumer. To achieve some of the efficiencies and cost savings described in more detail below, the business may require the consumer to purchase other non-fuel goods or services along with the fuel card 20. For example, if the business 12 is a grocery store, it may permit a consumer to purchase a discount fuel card 20 having a $50 fuel value if the consumer also buys $50 or more worth of groceries or other non-fuel goods or services. The particular value of the fuel card and the amount of non-fuel goods or services that must be purchased with the fuel card, if any, can be varied by the business to achieve any desired level of efficiencies and cost savings.

The fuel card 20 sold to the consumer either includes a pre-existing identification number or is encoded with an identification number by the point-of-sale equipment. The identification number may be an ISO or IIN compatible number and includes a range of numbers or symbols which identifies the discount fuel program and/or the host computer and a range of numbers or symbols which identify a unique account number for the cardholder. The fuel cards may be set up and used as discount fleet cards and have corresponding IIN number ranges which permit them to be processed outside of credit card settlement methods as described below. The card may also include or be encoded with a password, a random ID, the cardholder's name, and other identifying information. Once the discount fuel card has been purchased, the business 12 transmits the card identification number and an indication of the purchased fuel value to the host computer system 14 as depicted in block 302.

The host computer system 14 stores the card identification number and the value of the card in a database or other memory. The host computer system is preferably configured to store information about numerous cards and to serve as a financial clearinghouse for authenticating the fuel cards when they are used at the fuel stations 16 and for settling funds between the business 12 and the participating fuel stations 16 as described below. The host computer system 14 may also be configured to coordinate multiple discount fuel programs operated by different businesses. For example, the host computer system may include separate databases for a discount fuel program offered by a grocery store and a different discount fuel program offered by a different grocery store or other business. When multiple discount fuel programs are handled by the host computer system, the fuel card identification numbers or other codes must be set-up to differentiate the different programs.

The holder of the fuel card 20 may then use the card at any one of the participating fuel stations 16 to purchase fuel as depicted in block 304. The card may include a list or other identification of all participating fuel stations, or this information may be conveyed to the cardholder by other means.

When the fuel card 20 is inserted into a credit card reader or other card reader at the fuel pump 32 of the fuel station 16, the fuel pump recognizes the identification number on the card as being a part of the discounted fuel program. The fuel station then sends a request for card authorization to the host computer system 14 as depicted in block 306. Once the card has been authorized, the fuel pump rolls back its posted price to reflect the discount provided by the fuel card as depicted in block 308. Once the fuel has been dispensed, the fuel pump 32 or other computing equipment at the fuel station 16 transmits an indication of the total price of the fuel dispensed to the host computer system 14.

At the end of each day or at some other interval, the host computer system 14 settles funds between the fuel station 16 and the business 12 as depicted in block 310. The host computer may do this by various means. For example, the host computer system 14 may instruct a bank associated with the business 12 to transfer funds to a bank associated with the fuel station 16. Alternatively, the host computer may be operated by a financial network that does business with or is otherwise affiliated with both the business and the fuel station. In this case, the host computer system merely transfers funds from an account held by the business to an account held by the fuel station. Although not preferred, the host computer may also send an invoice to the business which instructs the business to pay the requisite funds to the fuel station.

After the fuel card 20 has been used by the consumer, the host computer system 14 deducts the spent amount from the stored value on the fuel card. For example, if the fuel card is purchased and initially loaded with $50 in fuel value, and the holder of the card purchases $30 worth of fuel from the fuel station, the host computer deducts the $30 from the stored value of the card. Then, the next time the fuel card is used, the host computer system notifies the fuel station that the card only has $20 worth of remaining fuel value.

At any time, the holder of the fuel card 20 may add additional value to the card by purchasing it from the business 12. For example, if the business is a grocery store, the holder of the card may add an additional $50 of fuel value to the card when purchasing $50 or more worth of groceries or other non-fuel goods or services from the grocery store.

The fuel discounts described herein can be provided by the business 12 and the participating fuel stations 16 at little or no cost. The fuel station 16 is able to provide discounted fuel because it can accept the discount fuel card 20 without incurring traditional credit card processing fees. For example, a fuel station with an average 4% credit card fee and a non-discounted price of $3 per gallon may discount its price by 12 cents per gallon. However, the particular discount provided does not necessarily need to be tied to the exact savings in credit card transactional fees. The fuel station may decide, for example, that it wants to provide a greater or lesser discount. Alternatively, the grocery store or other business which issues the fuel cards may mandate that all participating fuel stations provide the same discount (e.g. 5%). Regardless of the discount, the fuel pump 32 rolls back its posted price right at the pump, so the consumer immediately knows he or she is receiving the discount and is therefore more likely to frequent the fuel station on a regular basis. The fuel station therefore benefits from the discounted fuel program because it can sell discounted fuel without losing revenue and may actually gain revenue through increased customer loyalty.

The grocery store or other business 12 is able to provide the discount fuel card 20 for little or not cost for several reasons. First, the grocery store is charged lower fees by the credit card companies because it verifies signatures and has lower risks. Therefore, when a consumer pays for a fuel card 20 with a credit card, the grocery store may only have a 2% credit card fee whereas the fuel station would have had a 4% fee. This results in a savings of 6 cents per gallon of fuel when the fuel has a normal price of $3 per gallon.

Second, because the grocery store has a higher percentage of purchases made with cash or checks, the fuel card 20 is likely to be purchased without incurring any credit card fees. For example, a consumer may purchase a $50 fuel card and $60 worth of groceries with a check for $110, thus incurring no credit card fees. If the fuel or fuel card would have been purchased directly from the fuel station, there is a much greater likelihood that a credit card would have been used for the purchase.

Third, even if the fuel card 20 is purchased with a credit card, the transactional switch fee charged by the credit card companies is no more than it would have been without the sale of the fuel card because the grocery store requires purchase of non-fuel items with the fuel card in a single transaction.

Fourth, the grocery store 12 gets to keep the money paid for the fuel card 20 until it is used to purchase fuel and gets to keep at least a portion of the price paid for lost or otherwise unused fuel cards. Specifically, the grocery store collects the price paid for the fuel card at the time of purchase and may deposit this money in an interest-bearing account. The grocery store may then continue to draw interest on the money until it is paid to a participating fuel station at the time of settlement. Moreover, the fuel card 20, along with all other stored value cards, gift certificates, etc., are subject to being lost or otherwise not used. This is commonly referred to as “shatter”. Subject to applicable laws, the grocery store gets to keep all or part of the unused value of the issued fuel cards.

By combining all of these cost savings, efficiencies and benefits, the grocery store 12 or other business may offer the discount fuel card 20 at no charge or a minimal charge. In some embodiments, the grocery store may even realize enough savings and efficiencies to sell the discount fuel card at a reduced price, e.g. offering a $50 fuel card for $49. Alternatively, if the cost savings, efficiencies and benefits don't fully offset the costs of the discount fuel program, the grocery store or other business may charge the participating fuel stations and/or the consumers a small fee. The business may also offer other benefits for buying and using the fuel card. For example, if the business is a grocery store, it may award “shopper card points” that can be redeemed for free or discounted merchandise or services at the grocery store or the fuel station.

The grocery store or other business which initially sells the discount fuel card or the fuel stations which accept the card may also add value to the card beyond the amount purchased by the consumer. The entity which sells the card may add value to the card when a consumer buys promotional items. For example, when a consumer buys four 2-liter bottles of Coke® from the issuer of the card, he may receive an additional $2 on his fuel card. Similarly, the issuer of the card may add value when a consumer purchases a certain amount of groceries or other items. For example, a consumer may receive $2 credit on her fuel card for every $100 worth of groceries purchased. The entity which sells the card may also convert reward points and other credits from loyalty cards to a fuel card. For example, a consumer may receive $5 credit on his fuel card for every 1,000 points on a frequent shopper card.

Similarly, the fuel stations which accept the cards may add value to the cards when consumers purchase non-fuel items at the fuel stations. For example, if a consumer buys a soda and a sandwich he may receive $0.50 on his fuel card. A fuel station or the issuing business may also add additional value to a fuel card based on repeated use of the card. For example, a consumer may receive $2 credit on her card for every fifth time she uses the card for a vehicle fill-up or every time she adds an additional $50 in value to the card.

Although the invention has been described with reference to the preferred embodiment illustrated in the attached drawing figures, it is noted that equivalents may be employed and substitutions made herein without departing from the scope of the invention as recited in the claims. For example, the computer programs and equipment illustrated and described herein are merely examples of programs and equipment that may be used to implement embodiments of the present invention and may be replaced with other software and computer equipment without departing from the scope of the present invention.

Having thus described the preferred embodiment of the invention, what is claimed as new and desired to be protected by Letters Patent includes the following:

1. A method for providing discounted fuel to consumers, the method comprising the steps of:
issuing a discount fuel card to a consumer who purchases at least a specified amount of non-fuel goods or services;
charging the consumer an amount approximately equal to a fuel value which the consumer wishes to add to the card plus a price of the non-fuel goods or services;
crediting additional value to the fuel card based on an action taken by the consumer to arrive at a total fuel value for the card;
storing an identification number for the card and an indication of the total fuel value of the card in a computer;
permitting the consumer to use the discount fuel card to purchase fuel up to the amount of the total fuel value at a fuel station;
authorizing the fuel station to accept the card;
providing information to the fuel station which instructs the fuel station to sell the fuel to the consumer at a discount price; and
paying the fuel station an amount approximately equal to the discount price.

2. The method as set forth in claim 1, wherein the action taken by the consumer includes purchasing a promotional item from an entity which issues the fuel card.

3. The method as set forth in claim 1, wherein the action taken by the consumer includes purchasing a selected value of the non-fuel goods or services from an entity which issues the fuel card.

4. The method as set forth in claim 1, wherein the action taken by the consumer includes purchasing a promotional item from the fuel station.

5. The method as set forth in claim 1, wherein the crediting step is performed before the fuel card is first used by the consumer to purchase fuel.

6. The method as set forth in claim 1, wherein the crediting step is performed after the fuel card is first used by the consumer to purchase fuel.

7. The method as set forth in claim 1, wherein the action taken by the consumer includes using the fuel card a selected number of times to purchase fuel at the fuel station.

8. The method as set forth in claim 1, wherein the issuing step is performed by an entity selected from the group consisting of a grocery store, a liquor store, a convenience store, a clothing store, a hardware store, a drug store, a discount store, a warehouse store, a sporting goods store, a restaurant, and a financial institution.

9. The method as set forth in claim 1, wherein the paying step includes the step of settling an amount of money to be transferred from an issuer of the card to the fuel station.

10. The method as set forth in claim 1, further including the step of determining the discount price for the fuel by taking into account lower transactional costs of an issuer of the card as compared to the fuel station.

11. A system for selling discounted fuel, the system comprising:
point-of-sale equipment for issuing a discount fuel card and operable to associate the card with an identification number and an indication of a total fuel value which consists of a fuel value purchased by a consumer and an additional value based on an action taken by the consumer;
a computer in communication with the point-of-sale equipment for storing the identification number and the indication of the total fuel value; and
a computing device at a fuel station which is in communication with the computer, the computing device being operable to receive the fuel card and direct a fuel pump to dispense discounted fuel which is below a price posted at the fuel pump.

12. The system as set forth in claim 11, wherein the action taken by the consumer includes purchasing a promotional item from an entity which issues the fuel card.

13. The system as set forth in claim 11, wherein the action taken by the consumer includes purchasing a selected value of the non-fuel goods or services from an entity which issues the fuel card.

14. The system as set forth in claim 11, wherein the action taken by the consumer includes purchasing a promotional item from the fuel station.

15. The system as set forth in claim 11, wherein the action taken by the consumer includes using the fuel card a selected number of times to purchase fuel at the fuel station.

16. The system as set forth in claim 11, wherein the point-of-sale equipment is operated by an entity selected from the group consisting of a grocery store, a liquor store, a convenience store, a clothing store, a hardware store, a drug store, a discount store, a warehouse store, a sporting goods store, a restaurant, and a financial institution.

17. The system as set forth in claim 11, wherein the computer is operated by a closed, private network not associated with a credit card company.

18. The system as set forth in claim 11, wherein the discounted price takes into account a lower transactional cost of an issuer of the card.

19. The system as set forth in claim 11, wherein the point-of-sale equipment requires purchase of an amount of non-fuel goods or services in order to issue the card.
